(19) United States
(12) Patent Application Publication
(10) Pub. No.: US 2021/0296661 A1
(43) Pub. Date: Sep. 23, 2021

(54) FUEL CELL STACK, BIPOLAR PLATE, AND GAS DIFFUSION LAYER

(71) Applicant: TSINGHUA UNIVERSITY, Beijing (CN)

(72) Inventors: LING XU, Beijing (CN); JIAN-QIU LI, Beijing (CN); LIANG-FEI XU, Beijing (CN); ZUN-YAN HU, Beijing (CN); HUI-ZE LIU, Beijing (CN); ZHI-NA WANG, Beijing (CN); MING-GAO OUYANG, Beijing (CN)

(21) Appl. No.: 17/340,331

(22) Filed: Jun. 7, 2021

Related U.S. Application Data
(63) Continuation of application No. PCT/CN2020/070452, filed on Jan. 6, 2020.

(30) Foreign Application Priority Data
Dec. 23, 2019 (CN) 201911337875.X

(51) Int. Cl. H01M 8/0267; H01M 8/0258; H01M 8/04089; H01M 8/2465

(52) U.S. Cl. CPC H01M 8/0267; H01M 8/2465; H01M 8/04089; H01M 8/0258

(57) ABSTRACT

The present disclosure relates to a fuel cell stack, a bipolar plate, and a gas diffusion layer. The fuel cell stack includes a plurality of first graphite bipolar plates, a plurality of second graphite bipolar plates, and a plurality of reacting units arranged in sequence. The first graphite bipolar plate includes an air flow channel, a hydrogen gas flow channel, and a cooling flow channel. At least one second graphite bipolar plate is disposed between two adjacent first graphite bipolar plates. The second graphite bipolar plate includes an air flow channel and a hydrogen gas flow channel. A reacting unit is disposed between any two adjacent bipolar plates.

### CROSS-REFERENCE TO RELAYED APPLICATIONS

This application claims priority of China Patent Application No. 201911337875.X, filed on Dec. 23, 2019, entitled “FUEL CELL STACK, BIPOLAR PLATE, AND GAS DIFFUSION LAYER”, the content of which is hereby incorporated by reference in its entirety. This application is a continuation under 35 U.S.C. § 120 of international patent application PCT/CN2020/070452, filed on Jan. 6, 2020, the content of which is also hereby incorporated by reference in its entirety.

### TECHNICAL FIELD

The present disclosure relates to the field of new energy technologies, and particularly relates to fuel cell stacks, bipolar plates, and gas diffusion layers.

### BACKGROUND

Fuel cells are energy conversion devices that directly convert chemical energy into electricity, have characteristics such as high-efficiency, low noise, and environmental friendliness, and possess huge development potential and application prospects. Three key-components of a fuel cell are the membrane electrode assembly, the bipolar plates, and the gas diffusion layers.

The membrane electrode assembly is composed of a proton exchange membrane and catalyst layers located on two sides thereof. The catalyst layers are the places where electrochemical reactions are carried out. Hydrogen gas undergoes an oxidation reaction at the anode catalyst layer. Oxygen gas undergoes a reduction reaction forming water at the cathode catalyst layer. The bipolar plates are commonly made of metal or graphite. The fuel cells have not yet been commercialized, and the key limiting factors are power density and durability of the fuel cells. The fuel cells having metal bipolar plates have high power density but poor durability, whereas those having graphite bipolar plates have excellent durability but low power density. Therefore, how to improve the performance of the fuel cells is an issue to be promptly addressed.

### SUMMARY

In view of this, there is a need to provide a fuel cell stack, a bipolar plate, and a gas diffusion layer to increase the power density of the fuel cell stack and improve the performance of the fuel cell.

A fuel cell stack includes a plurality of first graphite bipolar plates, a plurality of second graphite bipolar plates, and a plurality of reacting units arranged in sequence. The first graphite bipolar plate includes a first surface and a second surface opposite to each other. The first surface defines an air flow channel. The second surface defines a hydrogen gas flow channel. A cooling flow channel is defined between the first surface and the second surface. At least one second graphite bipolar plate is disposed between two adjacent first graphite bipolar plates. The second graphite bipolar plate includes a third surface and a fourth surface opposite to each other. The third surface defines the air flow channel. The fourth surface defines the hydrogen gas flow channel. An air-channel opening of the air flow channel of any bipolar plate and a hydrogen-channel opening of the hydrogen gas flow channel of an adjacent bipolar plate are in alignment with and spaced from each other. One reacting unit is disposed between any two adjacent bipolar plates.

In some embodiments, each of the first graphite bipolar plates includes a cathode plate and an anode plate. The cathode plate includes a first cathode surface and a second cathode surface opposite to each other. The first cathode surface defines the air flow channel. The first cathode surface is the first surface. The anode plate includes a first anode surface and a second anode surface opposite to each other. The first anode surface defines the cooling flow channel. The second anode surface is the second surface. The second anode surface defines the hydrogen gas flow channel. The first anode surface is in contact with the second cathode surface.

In some embodiments, the cooling flow channel and the hydrogen gas flow channel are arranged in a staggered manner.

In some embodiments, the air flow channel, the hydrogen gas flow channel, or the cooling flow channel is formed by using a laser etching method.

In some embodiments, the air flow channel, the hydrogen gas flow channel, or the cooling flow is formed by a high-energy laser on a surface of a graphite bipolar plate blank to obtain the first graphite bipolar plates or the second graphite bipolar plates.

In some embodiments, the graphite bipolar plate blank is a molded flexible graphite substrate.

In some embodiments, each of the reacting units includes two gas diffusion layers opposite to each other and a membrane electrode assembly disposed between the two gas diffusion layers.

In some embodiments, a thickness of the gas diffusion layer is smaller than 0.2 mm.

In some embodiments, a width of the air flow channel, the hydrogen gas flow channel, or the cooling flow channel is smaller than 0.6 mm.

In some embodiments, a rib is defined between two adjacent flow channels, and a width of the rib is smaller than 0.6 mm.

In some embodiments, neither a thickness of the first graphite bipolar plate nor a thickness of the second graphite bipolar plate exceeds 2 mm.

In some embodiments, neither a thickness at a bottom of the air flow channel nor at the bottom of the hydrogen gas flow channel exceeds 0.5 mm.

A graphite bipolar plate includes flow channels. A width of each of the flow channels is smaller than 0.6 mm.

In some embodiments, a rib is defined between two adjacent flow channels, and a width of the rib is smaller than 0.6 mm.

In some embodiments, a thickness at a bottom of the flow channels does not exceed 0.5 mm.

In some embodiments, the graphite bipolar plate includes a cathode plate and an anode plate. The cathode plate includes a first cathode surface and a second cathode surface opposite to each other. The first cathode surface defines an air flow channel. The anode plate includes a first anode surface and a second anode surface opposite to each other. The first anode surface defines a cooling flow channel. The second anode surface defines a hydrogen gas flow channel. The first anode surface is in contact with the second cathode surface.

In some embodiments, the graphite bipolar plate includes a cathode plate and an anode plate. The cathode plate includes a first cathode surface and a second cathode surface opposite to each other. The first cathode surface defines an air flow channel. The second cathode surface defines a cooling flow channel. The anode plate includes a first anode surface and a second anode surface opposite to each other. The second anode surface defines a hydrogen gas flow channel. The first anode surface is in contact with the second cathode surface.

In some embodiments, the air flow channel, the hydrogen gas flow channel, or the cooling flow is formed by a high-energy laser on a surface of a graphite bipolar plate blank to obtain the graphite bipolar plate.

In some embodiments, the graphite bipolar plate blank is a molded flexible graphite substrate.

A gas diffusion layer, wherein a thickness of the gas diffusion layer is smaller than 0.2 mm.

The fuel cell stack provided in the embodiments of the present disclosure includes a plurality of first graphite bipolar plates, a plurality of second graphite bipolar plates, and a plurality of reacting units arranged in sequence. The first graphite bipolar plate includes a first surface and a second surface opposite to each other. The first surface defines an air flow channel. The second surface defines a hydrogen gas flow channel. A cooling flow channel is defined between the first surface and the second surface. At least one second graphite bipolar plate is disposed between two adjacent first graphite bipolar plates. The second graphite bipolar plate includes a third surface and a fourth surface opposite to each other. The third surface defines the air flow channel. The fourth surface defines the hydrogen gas flow channel. An air-channel opening of the air flow channel of any bipolar plate and a hydrogen-channel opening of the hydrogen gas flow channel of an adjacent bipolar plate are in alignment with and spaced from each other. One reacting unit is disposed between any two adjacent bipolar plates.

Compared with prior art, the thickness of the second graphite bipolar plate is reduced. Two adjacent bipolar plates and one reacting unit constitute one single cell. The volume and thermal resistivity of the single cell are reduced. Two adjacent first graphite bipolar plates cool the one or more second graphite bipolar plates disposed therebetween, which can result in a good heat dissipation effect. The thickness of the second bipolar plate is 40% smaller than that of the first bipolar plate. The more the single cells per unit volume, the larger the electricity output, and the higher the power density of the fuel cell stack 10; therefore, the performance of the fuel cell is improved.

### BRIEF DESCRIPTION OF THE DRAWINGS

In order to illustrate the embodiments of the present disclosure more clearly, the drawings used in the embodiments will be described briefly. Apparently, the following described drawings are merely for the embodiments of the present disclosure, and other drawings can be derived by those of ordinary skill in the art without any creative effort.

FIG. 1 is a schematic structural view of a fuel cell stack provided in an embodiment of the present disclosure.

FIG. 2 is a schematic structural view of a fuel cell stack provided in another embodiment of the present disclosure.

FIG. 3 is a schematic structural view of a gas diffusion layer provided in an embodiment of the present disclosure.

FIG. 4 is a performance test diagram of a single cell having a dense flow field provided in some embodiments of the present disclosure.

### DETAILED DESCRIPTION

The present disclosure will now be described in detail with reference to the accompanying drawings and embodiments in order to make the objects, technical solutions, and advantages of the present disclosure more clear. It should be understood that the specific embodiments described herein are only for explaining the present disclosure, and not intended to limit the present disclosure.

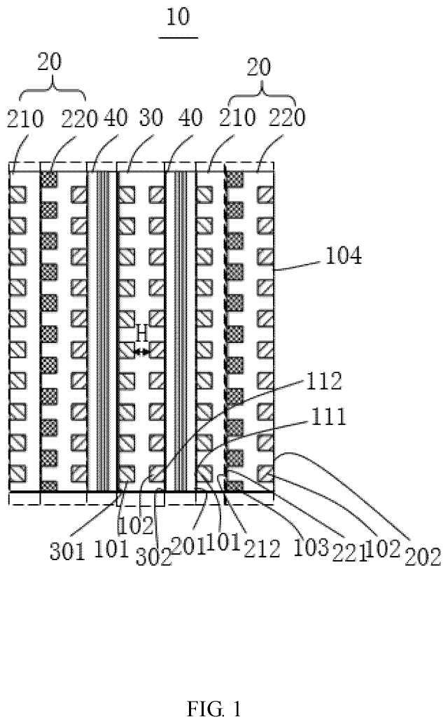

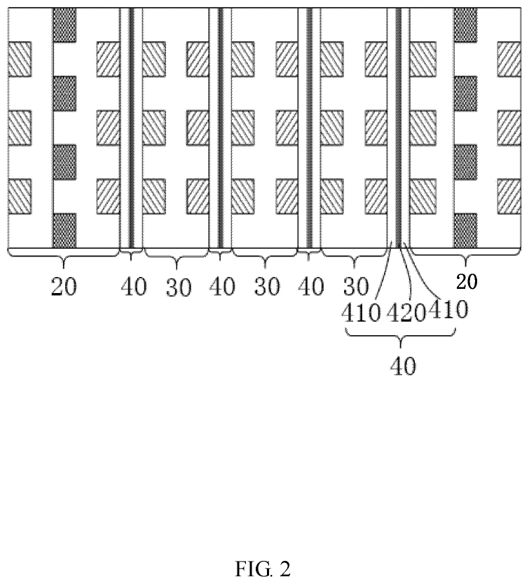

Referring to FIG. 1 and FIG. 2, the present disclosure provides an embodiment of a fuel cell stack 10. The fuel cell stack 10 includes a plurality of first graphite bipolar plates 20, a plurality of second graphite bipolar plates 30, and a plurality of reacting units 40 arranged in sequence. The first graphite bipolar plates 20 each include a first surface 201 and a second surface 202 opposite to each other. The first surface 201 defines an air flow channel 101. The second surface 202 defines a hydrogen gas flow channel 102. A cooling flow channel 103 is defined between the first surface 201 and the second surface 202. At least one second graphite bipolar plate 30 is disposed between two adjacent first graphite bipolar plates 20. The second graphite bipolar plates 30 each include a third surface 301 and a fourth surface 302 opposite to each other. The third surface 301 defines an air flow channel 101. The fourth surface 302 defines a hydrogen gas flow channel 102. An air-channel opening 111 of the air flow channel 101 of any bipolar plate and a hydrogen-channel opening 112 of the hydrogen gas flow channel 102 of an adjacent bipolar plate are in alignment with and spaced from each other. One reacting unit 40 is disposed between any two adjacent bipolar plates.

In the embodiment of the fuel cell stack 10 provided by the present disclosure, the thickness of the second graphite bipolar plate 30 is reduced. Two adjacent bipolar plates and one reacting unit 40 constitute one single cell. The volume and thermal resistivity of the single cell are reduced. Two adjacent first graphite bipolar plates 20 cool the one or more second graphite bipolar plates 30 disposed therebetween, which can result in a good heat dissipation effect. The thickness of the second bipolar plate is 40% smaller than that of the first bipolar plate. The more the single cells per unit volume, the larger the electricity output, and the higher the power density of the fuel cell stack 10; therefore, the performance of the fuel cell is improved.

Power density refers to a ratio of rated power or maximum power of a fuel cell to a volume or mass of the fuel cell, which is therefore the volume power density or the mass power density. The term “power density” mentioned in the present disclosure refers to the volume power density. Generally, as the volume power density increases, the mass power density increases accordingly.

In prior art, metal ions are precipitated during use of a metal bipolar plate, corroding the proton exchange membrane and severely reducing the service life of the fuel cell. In the present disclosure, the first graphite bipolar plate 20 and the second graphite bipolar plate 30 are both made of graphite materials. The graphite bipolar plates do not precipitate metal ions, therefore do not affect the proton exchange membrane, and are durable.

On the condition that a first graphite bipolar plate 20 is adjacent to a second graphite bipolar plate 30, the air-channel opening 111 of the air flow channel 101 of the first graphite bipolar plate 20 and the hydrogen-channel opening 112 of the hydrogen gas flow channel 102 of the second graphite bipolar plate 30 are in alignment with and spaced from each other. One reacting unit 40 is disposed between the first graphite bipolar plate 20 and the second graphite bipolar plate 30.

On the condition that two second graphite bipolar plates 30 are adjacent to each other, the air-channel opening 111 of the air flow channel 101 of one second graphite bipolar plate 30 and the hydrogen-channel opening 112 of the hydrogen gas flow channel 102 of another second graphite bipolar plate 30 are in alignment with and spaced from each other. One reacting unit 40 is disposed between the two second graphite bipolar plates 30.

The hydrogen gas flow channel 102 is configured for circulation of hydrogen gas. The air flow channel 101 is configured for circulation of air. The cooling flow channel 103 is configured for circulation of coolant.

The reacting units 40 are configured to carry out the electrochemically reaction between the hydrogen gas and the oxygen gas, thereby generating electricity. The electrochemical reaction generates electricity while releasing heat, which elevates temperatures of the bipolar plates and the reacting units 40 in the fuel cell stack 10. The coolant is configured for cooling the bipolar plates and the reacting units 40.

In some embodiments, each of the first graphite bipolar plates 20 includes a cathode plate 210 and an anode plate 220. The cathode plate 210 includes a first cathode surface and a second cathode surface 212 opposite to each other. The first cathode surface defines the air flow channel 101. The first cathode surface is the first surface 201. The anode plate 220 includes a first anode surface 221 and a second anode surface opposite to each other. The first anode surface 221 defines the cooling flow channel 103. The second anode surface is the second surface 202. The second anode surface defines the hydrogen gas flow channel 102. The first anode surface 221 is in contact with the second cathode surface 212.

In some embodiments, each of the first graphite bipolar plates 20 includes the cathode plate 210 and the anode plate 220. The cathode plate 210 includes the first cathode surface and the second cathode surface 212 opposite to each other. The first cathode surface defines the air flow channel 101. The first cathode surface is the first surface 201. The second cathode surface 212 defines the cooling flow channel 103. The anode plate 220 includes the first anode surface 221 and the second anode surface opposite to each other. The second anode surface is the second surface 202. The second anode surface defines the hydrogen gas flow channel 102. The first anode surface 221 is in contact with the second cathode surface 212.

In some embodiments, the cooling flow channel 103 and the hydrogen gas flow channel 102 are arranged in a staggered manner, which improves cooling efficiency of the coolant on ribs between the flow channels.

In some embodiments, the cooling flow channel 103 and the hydrogen gas flow channel 102 are in alignment with each other.

In some embodiments, the air flow channel 101, the hydrogen gas flow channel 102, or the cooling flow channel 103 are formed by using a laser etching method.

In some embodiments, a high-energy laser is used to form the air flow channel 101, the hydrogen gas flow channel 102, or the cooling flow channel 103 on a surface of a graphite bipolar plate blank to obtain the first graphite bipolar plate 20 or the second graphite bipolar plate 30.

The high-energy laser includes a nanosecond laser, a picosecond laser, or a femtosecond laser. The high-energy laser processing does not generate mechanical stress and will not form processing defects at the bottom of the flow channels. Therefore, a thickness at the bottom of the flow channels can be reduced from about 1 mm of a conventional graphite bipolar plate to 0.6 mm or even smaller.

In some embodiments, the graphite bipolar plate blank is a molded flexible graphite substrate including roughly machined flow channels. The roughly machined flow channels are finely etched by the high-energy laser to reduce the thickness at the bottom of the flow channels to 0.2 mm, thereby significantly reducing the thickness of the graphite bipolar plates. The reduction in the thickness of the bipolar plates reduces the volume of the fuel cell, the impedance of electron transport, and the polarization loss of the bipolar plates, thereby increasing the power density of the fuel cell stack and increasing the performance of the fuel cell.

In some embodiments, neither the thickness H at the bottom of the air flow channel 101 nor that at the bottom of the hydrogen gas flow channel 102 exceeds 0.5 mm, so that the plurality of first graphite bipolar plates 20 and the plurality of second graphite bipolar plates 30 having the air flow channels 101 and the hydrogen gas flow channels 102 are all ultra-thin bipolar plates.

At least one second graphite bipolar plate 30 is disposed between two adjacent first graphite bipolar plates 20 to form an interval cooling structure.

A conventional single cell having graphite bipolar plates is relatively thick, which make the heat of the bipolar plate without the cooling flow channel difficult to be dissipated by the coolant that is far away from the bipolar plate without the cooling flow channel in the interval cooling structure since thermal resistance is directly proportional to heat conduction distance. Heat accumulation will increase the temperature of the local area, which reduces the performance and lifespan of the fuel cell. Therefore, the bipolar plates adopted in the interval cooling structure should have reduced thicknesses.

In some embodiments, the thickness of each of the first graphite bipolar plate 20 and the second graphite bipolar plate 30 does not exceed 2 mm.

By adopting the ultra-thin bipolar plates, the overall thickness of the single cell is reduced. Even in the interval cooling structure, the distance between the second graphite bipolar plate 30 without the cooling flow channel and the coolant is small enough for the coolant to dissipate the heat generated in the second graphite bipolar plate 30, thus not causing the above-described high-temperature issue of the local area.

The graphite bipolar plate blank is processed by the high-energy laser. The high-energy laser plasmaizes the graphite material at the location of the flow channels, thereby etching the flow channels. The spot diameter at the focal point of the high-energy laser is only about a dozen to tens of microns, which can process fine flow channels. The high-energy laser processing has low thermal effect, generates no mechanical stress, and does not cause damage to the ribs and the bottoms of the flow channels. The high-energy laser has extremely high precision, which can be up to a few microns and meet the high precision requirement for processing a dense flow field. The high-energy laser is flexible and automated, and can automatically process various complex flow fields.

In some embodiments, a width of the air flow channel 101, the hydrogen gas flow channel 102, or the cooling flow channel 103 is smaller than 0.6 mm.

In some embodiments, a rib 104 is formed between two adjacent flow channels, and a width of the rib 104 is smaller than 0.6 mm.

In the above-described embodiments, the widths of the air flow channel 101, the hydrogen gas flow channel 102, the cooling flow channel 103, and the rib 104 are relatively small, so that the dense flow fields are formed on the surfaces of the first graphite bipolar plates 20 and the second graphite bipolar plates 30, which improves the power density of the fuel cell stack 10 and the performance of the fuel cell.

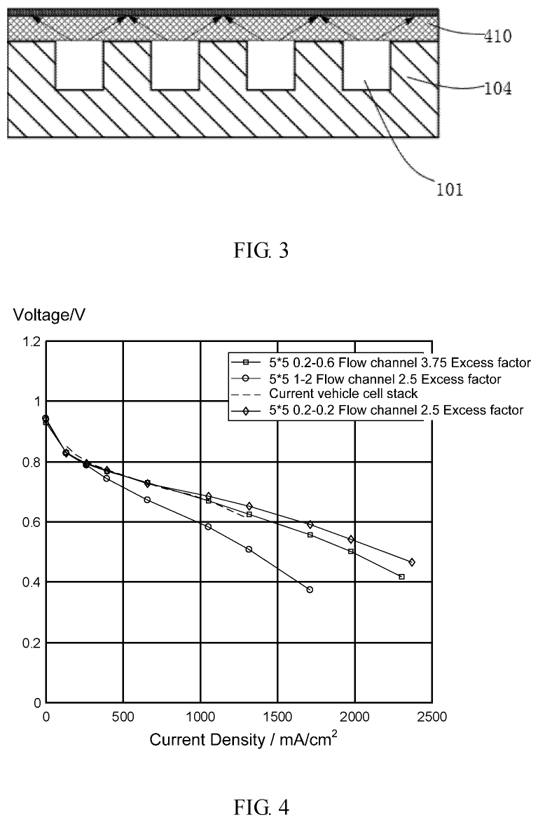

Referring also to FIG. 3, in some embodiments, each of the reacting units 40 includes a membrane electrode assembly 420 and two gas diffusion layers 410 opposite to each other. The membrane electrode assembly 420 is disposed between the two gas diffusion layers 410.

The membrane electrode assembly 420 is composed of a proton exchange membrane and catalyst layers located on two sides thereof. The catalyst layers are the places where electrochemical reactions are carried out. The hydrogen gas undergoes an oxidation reaction at an anode catalyst layer.

Oxygen gas undergoes a reduction reaction forming water at a cathode catalyst layer.

Relying on the flow channels alone is not enough to evenly distribute the gas throughout the catalyst layers, so that the gas diffusion layers are required between the bipolar plate and the membrane electrode assembly. The gas diffusion layer is a layer of porous medium with many micropores inside, and the reactants in the flow channels diffuse through these micropores to the catalyst layers. The water generated in the catalyst layers is also discharged into the flow channels through these micropores. The function of the gas diffusion layers is to ensure the uniformity of the gas distribution and increase the reaction area to improve the reaction efficiency.

The gas mainly diffuses in a direction perpendicular to the gas diffusion layers, but some gas diffuses in a direction parallel to the gas diffusion layers. The parallel diffusion make the gas diffuse from the flow channels to the catalyst layers behind the ribs. With respect to conventional flow channels, the width of the ribs is relatively large due to the processing limitation, and it is necessary to increase the time for the parallel diffusion of the gas in the gas diffusion layers in order to increase the reaction area, which needs to increase the thickness of the gas diffusion layers. However, the thicker the gas diffusion layers, the greater the resistance to the transport of the reactants, which will reduce the concentration of the reactants in the catalyst layers and affect the performance of the fuel cell.

In some embodiments, the thickness of each gas diffusion layer 410 is smaller than 0.2 mm. Since the flow channels of both the plurality of first graphite bipolar plates 20 and the plurality of second graphite bipolar plates 30 are densely distributed, the widths of the ribs are decreased. The parallel diffusion distance of the gas in the gas diffusion layer 410 is decreased, and the thickness of the gas diffusion layer 410 is smaller than 0.2 mm to meet the gas uniformity requirement.

Referring also to FIG. 4, in some embodiments, an experiment to test the performance of a single cell assembled with the bipolar plates having the dense flow field processed by the high-energy laser. After the dense flow field is formed, the polarization loss of the fuel cell is reduced and the performance is improved under the same current density. A fuel cell stack is assembled with the high-energy laser processed dense flow field single cells and tested. The test result is shown in FIG. 4. after the dense flow field is formed, at a current density of 1700 mA/cm², a voltage of the single cell having a width ratio of flow channel/rib=0.2 mm/0.2 mm is 200 mV higher than a voltage of the single cell having a width ratio of flow channel/rib=1 mm/1 mm. This sufficiently reveals that the power density of the dense flow field single cell is increased compared with the conventional flow field single cell, thereby improving the performance of the fuel cell. This is just the performance improvement brought by the use of the dense flow field of the bipolar plates. The ultra-thin bipolar plates and the ultra-thin gas diffusion layers of the fuel cell stack contribute to further reduction of mass transport resistance and ohmic impedance, which further reduces the polarization loss and improves the performance.

The thicknesses of the bipolar plates before and after adopting the present technical solution are compared in the following table.

| Name of the | Before using the present | | After using the present | |
|---|---|---|---|---|
| component | technical solution | | technical solution | |
| First graphite | 5 | mm | 1 | mm |
| bipolar plate | | | | |
| Second graphite | — | | 0.6 | mm |
| bipolar plate | | | | |
| Gas diffusion layer | 0.45 | mm | 0.2 | mm |
| Average thickness | 6 | mm | 1.3 | mm |
| of the single cell | | | | |

The average thickness of the single cell is a weighted average according to the ratio between the numbers of the two types of bipolar plates.

If one second graphite bipolar plate 30 is disposed between two adjacent first graphite bipolar plates 20, the ratio of the number of the first graphite bipolar plates 20 to that of the second graphite bipolar plates 30 is 1:1, then:

the average thickness of the single cell=the thickness of the reacting unit+the thickness of each first bipolar plate/2+the thickness of each second bipolar plate/2.

If two second graphite bipolar plates 30 are disposed between two adjacent first graphite bipolar plates 20, the ratio of the number of the first graphite bipolar plates 20 to that of the second graphite bipolar plates 30 is 1:2, then:

the average thickness of the single cell=the thickness of the reacting unit+the thickness of each first bipolar plate/3+the thickness of each second bipolar plate x2/3.

The total thickness of the fuel cell stack is equal to the average thickness of the single cell×the number of the single cells, which is convenient for comparison with the thickness of the single cell of a conventional fuel cell.

The fuel cell stack 10 adopts the first graphite bipolar plates 20 with the densely distributed flow channels and the small thickness at the bottoms of the flow channels in combination with the ultra-thin gas diffusion layers 410, which increases the power density and improves the performance of the fuel cell.

An embodiment of the present disclosure provides a graphite bipolar plate including flow channels. A rib is formed between two adjacent flow channels, and a width of the rib is smaller than 0.6 mm. The number of the flow channels per unit area increases.

In some embodiments, the graphite bipolar plate includes a cathode plate 210 and an anode plate 220. The cathode plate 210 includes a first cathode surface and a second cathode surface 212 opposite to each other. The first cathode surface defines the air flow channel 101. The first cathode surface is the first surface 201. The anode plate 220 includes a first anode surface 221 and a second anode surface opposite to each other. The first anode surface 221 defines the cooling flow channel 103. The second anode surface is the second surface 202. The second anode surface defines the hydrogen gas flow channel 102. The first anode surface 221 is in contact with the second cathode surface 212.

In some embodiments, the graphite bipolar plate includes the cathode plate 210 and the anode plate 220. The cathode plate 210 includes the first cathode surface and the second cathode surface 212 opposite to each other. The first cathode surface defines the air flow channel 101. The first cathode surface is the first surface 201. The second cathode surface 212 defines the cooling flow channel 103. The anode plate 220 includes the first anode surface 221 and the second anode surface opposite to each other. The second anode surface is the second surface 202. The second anode surface defines the hydrogen gas flow channel 102. The first anode surface 221 is in contact with the second cathode surface 212.

In some embodiments, neither the thickness H at the bottom of the air flow channel 101 nor that at the bottom of the hydrogen gas flow channel 102 exceeds 0.5 mm, so that the graphite bipolar plates having the air flow channels 101 and the hydrogen gas flow channels 102 are ultra-thin bipolar plates.

In some embodiments, the high-energy laser is used to form the air flow channel 101, the hydrogen gas flow channel 102, or the cooling flow channel 103 on a surface of a graphite bipolar plate blank to obtain the graphite bipolar plate.

The high-energy laser includes the nanosecond laser, picosecond laser, or femtosecond laser. The high-energy laser processing does not generate mechanical stress and will not form processing defects at the bottom of the flow channels. Therefore, a thickness at the bottom of the flow channels can be reduced from about 1 mm of a conventional graphite bipolar plate to 0.6 mm or even smaller.

In some embodiments, the graphite bipolar plate blank is a molded flexible graphite substrate including roughly machined flow channels. The roughly machined flow channels are finely etched by the high-energy laser to reduce the thickness at the bottom of the flow channels to 0.2 mm, thereby significantly reducing the thickness of the graphite bipolar plates. The reduction in the thickness of the bipolar plates reduces the volume of the fuel cell, the impedance of electron transport, and the polarization loss of the bipolar plates, thereby increasing the power density of the fuel cell stack and increasing the performance of the fuel cell.

In some embodiments, the thickness H at the bottom of the air flow channel 101 does not exceed 0.5 mm, so that the graphite bipolar plate is an ultra-thin bipolar plate.

An embodiment of the present disclosure provides a gas diffusion layer 410 whose thickness is smaller than 0.2 mm and is applied to the fuel cell stack, so that the volume of the fuel cell stack is reduced.

The technical features of the above-mentioned embodiments can be combined arbitrarily. In order to make the description concise, not all possible combinations of the technical features are described in the embodiments. However, as long as there is no contradiction in the combination of these technical features, the combinations should be considered as in the scope of the present disclosure.

The above-described embodiments are only several implementations of the present disclosure, and the descriptions are relatively specific and detailed, but they should not be construed as limiting the scope of the present disclosure. It should be understood by those of ordinary skill in the art that various modifications and improvements can be made without departing from the concept of the present disclosure, and all fall within the protection scope of the present disclosure. Therefore, the patent protection of the present disclosure shall be defined by the appended claims.

What is claimed is:

1. A fuel cell stack, comprising:
a plurality of first graphite bipolar plates, each of the first graphite bipolar plates comprising a first surface and a second surface opposite to each other, the first surface defining an air flow channel, the second surface defining a hydrogen gas flow channel, and a cooling flow channel being defined between the first surface and the second surface;
a plurality of second graphite bipolar plates, at least one of which being disposed between two adjacent first graphite bipolar plates, each of the second graphite bipolar plates comprising a third surface and a fourth surface opposite to each other, the third surface defining the air flow channel, and the fourth surface defining the hydrogen gas flow channel; and
a plurality of reacting units, one of which being disposed between any two adjacent bipolar plates;
wherein an air-channel opening of the air flow channel of any bipolar plate and a hydrogen-channel opening of the hydrogen gas flow channel of an adjacent bipolar plate are in alignment with and spaced from each other.

2. The fuel cell stack of claim 1, wherein each of the first graphite bipolar plates further comprises:
a cathode plate comprising a first cathode surface and a second cathode surface opposite to each other, the first cathode surface defining the air flow channel, and the first cathode surface being the first surface; and
a anode plate comprising a first anode surface and a second anode surface opposite to each other, the first anode surface defining the cooling flow channel, the second anode surface being the second surface, the second anode surface defining the hydrogen gas flow channel, and the first anode surface being in contact with the second cathode surface.

3. The fuel cell stack of claim 2, wherein the cooling flow channel and the hydrogen gas flow channel are arranged in a staggered manner.

4. The fuel cell stack of claim 1, wherein the air flow channel, the hydrogen gas flow channel, or the cooling flow channel is formed by using a laser etching method.

5. The fuel cell stack of claim 4, wherein the air flow channel, the hydrogen gas flow channel, or the cooling flow is formed by a high-energy laser on a surface of a graphite bipolar plate blank to obtain the first graphite bipolar plates or the second graphite bipolar plates.

6. The fuel cell stack of claim 5, wherein the graphite bipolar plate blank is a molded flexible graphite substrate.

7. The fuel cell stack of claim 1, wherein each of the reacting units comprises:
two gas diffusion layers opposite to each other; and
a membrane electrode assembly disposed between the two gas diffusion layers.

8. The fuel cell stack of claim 7, wherein a thickness of each of the gas diffusion layers is smaller than 0.2 mm.

9. The fuel cell stack of claim 1, wherein a width of the air flow channel, the hydrogen gas flow channel, or the cooling flow channel is smaller than 0.6 mm.

10. The fuel cell stack of claim 1, wherein a rib is defined between two adjacent flow channels, and a width of the rib is smaller than 0.6 mm.

11. The fuel cell stack of claim 1, wherein neither a thickness of the first graphite bipolar plate nor a thickness of the second graphite bipolar plate exceeds 2 mm.

12. The fuel cell stack of claim 1, wherein neither a thickness at a bottom of the air flow channel nor a thickness at the bottom of the hydrogen gas flow channel exceeds 0.5 mm.

13. A graphite bipolar plate, comprising:
flow channels, wherein a width of each of the flow channels is smaller than 0.6 mm.

14. The graphite bipolar plate of claim 13, wherein a rib is defined between two adjacent flow channels, and a width of the rib is smaller than 0.6 mm.

15. The graphite bipolar plate of claim 13, wherein a thickness at a bottom of the flow channels does not exceed 0.5 mm.

16. The graphite bipolar plate of claim 13, comprising:
a cathode plate comprising a first cathode surface and a second cathode surface opposite to each other, the first cathode surface defining an air flow channel;
a anode plate comprising a first anode surface and a second anode surface opposite to each other, the first anode surface defining a cooling flow channel, the second anode surface defining a hydrogen gas flow channel, and the first anode surface being in contact with the second cathode surface.

17. The graphite bipolar plate of claim 13, comprising:
a cathode plate comprising a first cathode surface and a second cathode surface opposite to each other, the first cathode surface defining an air flow channel, and the second cathode surface defining a cooling flow channel;
an anode plate comprising a first anode surface and a second anode surface opposite to each other, the second anode surface defining a hydrogen gas flow channel, and the first anode surface being in contact with the second cathode surface.

18. The graphite bipolar plate of claim 13, wherein the air flow channel, the hydrogen gas flow channel, or the cooling flow is formed by a high-energy laser on a surface of a graphite bipolar plate blank.

19. The graphite bipolar plate of claim 18, wherein the graphite bipolar plate blank is a molded flexible graphite substrate.

20. A gas diffusion layer, wherein a thickness of the gas diffusion layer is smaller than 0.2 mm.
